(19) United States
(12) Patent Application Publication
(10) Pub. No.: US 2007/0249778 A1
(43) Pub. Date: Oct. 25, 2007

(54) Elastomeric coating for corrosion control and chemical containment

(76) Inventors: Paul L. Clemens, Brookshire, TX (US); Thomas G. Priest, Houston, TX (US); Owen T. Priest, Houston, TX (US)

Correspondence Address: John R. Casperson, P O Box 2174, Friendswood, TX, 77549, US

(21) Appl. No.: 11/407,881

(22) Filed: Apr. 20, 2006

(51) Int. Cl. C09B 67/00

(52) U.S. Cl. 524/502

(57) ABSTRACT

A cost effective, two component, high-solids elastomeric coating. The coating is comprised of a chemically cross-linked resin for the purpose of substrate corrosion control, and chemical containment service. This invention may be applied by conventional application techniques including, but not limited to: brush applied, squeegee applied, roller applied, trowel applied, and both single and plural component spray applied. The coating may be optionally reinforced with fabric or fiber reinforcement layers, and the system components of the elastomeric coating to provide an engineered composite coating. The coating imparts excellent adhesive properties, in particular to: oil-contaminated substrates, a variety of low surface energy substrates, and on a variety of electronegative substrates. The invention's specific chemical resistive properties are designed such: for exposure to boiling water, resistance to brines, and resistance to a broad spectrum of solid and aqueous acids and caustics. The physical properties include excellent flexibility and the ability to elongate and contract across a broad temperature range (−100° F. to +260° F.). Performance properties of the installed coating include: weatherability, abrasion resistance, impact strength, chip resistance, and dimensional stability. Long-term aging properties of the material are exceptional.

### FIELD OF THE INVENTION

In preferred embodiments, the present invention relates to corrosion resistant resin compositions formed from blends of hydroxyl terminated butadienes and isocyanate terminated butadienes and in particular to a high solids elastomeric coating made from the blends for the purpose of corrosion control, for example, for the lining railcars, tanks, sumps and trenches, flooring and as a coating for structural steel and concrete. The invention also provides a chemical containment lining and an expansion joint sealant/caulk, as well as coating system components, system component compositions and methods of use.

### BACKGROUND OF THE INVENTION

The goal of the research project that resulted in this invention was to develop a new coating system that is high solids (goal-100% solids), to be a solvent free, elastomeric coating forming the basis of a polymer system for a number of products such as a coating/lining for the protection of both concrete and steel against chemicals in splash and spill situations, for spill containments as well as for full time chemical immersion. In addition, crack-bridging was required for application on concrete in containment spill conditions and possibly some flooring applications, as well as being used as a joint sealant/caulk in concrete expansion joints or in smoothing structural joints in steel tanks. Abrasion resistance was also a desirable attribute for many applications such as lining a rail hopper car carrying abrasive, solid powders.

Current product offerings in industrial corrosion control industry are either not EPA compliant now or will not be in the future because of the high solvent loading in joint sealants & caulks as well as flexible, high corrosion resistant coatings/linings. Other environmentally safe materials are aqueous based and cannot provide the chemical resistance and flexibility required in coatings/linings on substrates subject to movement, while containing/holding highly corrosive liquids and powders.

Acrylics provide faster cure, lower cost (since their equivalent weight is usually higher that of other polymers, resulting in the need for less of the more expensive isocyanate), and better exterior durability, resulting from superior hydrolytic and photochemical stability. However the chemical resistance is lacking when exposure to industrial chemicals is required. Nitrocellulose (shipped with plasticizer instead of ethyl or isopropyl alcohol) is used in formulating, however these types of coatings also exhibit limited chemical resistance capabilities. Bisphenol A epoxy resins prove to exhibit a good chemical resistance profiles to a variety of chemicals, however, they fail to maintain their flexibility while in service. Hydroxyl-terminated polyethers have limited usage, since the resulting coatings show high moisture vapor permeability, relatively poor exterior durability, and are soft as a result of the low T_{g} of the polyethers. Previous hydroxyl terminated butadiene coatings fail to exhibit the chemical composition sophistication and depth of engineering performance to achieve maximum physical and chemical resistance properties.

Another higher performance, higher cost coating/lining is disclosed by Priest, et. al., U.S. Pat. No. 5,814,693 utilizing chlorosulfonated polyethylene, achieving high chemical resistance, crack-bridging on concrete, fire retardance and superior UV & weather resistance. It is important to note that these materials require solvent to create a liquid coating, due to the high molecular weight of chlorosulfonated polyethylene, and while the solvent employed currently meets EPA requirements, the goal is to achieve similar performance without solvent and to have developed a coating/lining that has lower installed cost without solvent.

According, there exists a need for a more cost effective, highly engineered, high solids content, elastomeric coating, and system components, for use as a corrosion, and chemical exposure control membrane.

The present invention solves these needs by providing a cost effective shop and/or field applied coating/lining system that is ideally adapted for the purpose of corrosion control, and chemical containment on steel and concrete substrates.

The preferred ingredient ratios demonstrate marked improvement in cure times and ease of application; with good chemical resistance and physical properties over most other industry product offerings.

The novel scope and design of the present invention yields a high solids, (90% to 100% solids), VOC compliant material and system components, which exhibits desirable physical properties and chemical resistant properties versus the cost of comparable alternative materials.

### OBJECTS OF THE INVENTION

It is an object of the present invention to provide an improved field applied and/or shop applied, highly engineered, elastomeric, chemical and corrosion resistant, coating/lining system.

It is a further object of the invention to address improved application techniques that provide easier, more cost effective installation of the system.

Other objects and advantages of the present invention will become apparent as a description thereof proceeds.

### SUMMARY OF THE INVENTION

In one embodiment of the invention, there is provided a novel resin composition which comprises a polyhydroxy terminated polymer of butadiene having an average molecular weight in the range of 1,000 to 5,000 and an average hydroxyl functionality in the range of 1.9 to 4, in combination with a compatible amount of at least one reactive polymer component of lower molecular weight selected from the group consisting of a polyhydroxy-terminated polybutadiene, a polyhydroxy-terminated polyether, a polyhydroxy-terminated polyester, a polyhydroxy-terminated polyacrylate, a polyhydroxy-terminated propoxylated Bisphenol A, and a polyhydroxy-terminated polyester/polyether, said reactive polymer component having an average molecular weight in the range of 500 to 1500 and an average hydroxyl functionality in the range of 1.5 to 3.

In accordance with another embodiment of the invention, there is provided a novel hardener composition which comprises a polyisocyanate-terminated polybutadiene resin having an average molecular weight in the range of 1000 to 5000 and an NCO content in the range of 8 to 15 percent by weight together with a compatible amount of a multi-functional isocyanate having a molecular weight in the range of from about 200 to about 600.

In accordance with another embodiment of the invention, there is provided a curable resin composition comprising a blend of hydroxyl terminated polybutadienes and polyisocyanates. Preferably, the curable resin composition comprises, in combination, a Part A and a Part B. Part A contains polyhydroxy functionality and comprises a polyhydroxy terminated polymer of butadiene having an average molecular weight in the range of 1,000 to 5,000 and an average hydroxyl functionality in the range of 1.9 to 4. Part B contains NCO functionality and comprises at least one of a polyisocyanate-terminated polybutadiene having an average molecular weight in the range of 1000 to 5000 and an NCO content in the range of 8 to 15 percent by weight, and (ii) a multi-functional isocyanate having a molecular weight in the range of from about 200 to about 600. Part A and part B are combined in a near stoichiometric ratio between the polyhydroxy functionality and the NCO functionality. Other components may be optionally present, but it is preferred that any such components be selected so that the curable resin composition loses less than 20 percent of its weight as it cures.

In accordance with a further embodiment of the invention, there is provided for making a curable resin composition comprising a blend of a part A resin and a part B hardener. The method is carried out providing an amount by volume of the liquid part A resin and combining into it with stirring an amount of the liquid part B hardener. The part A resin contains polyhydroxy functionality and comprises a polyhydroxy terminated polymer of butadiene having an average molecular weight in the range of 1,000 to 5,000 and an average hydroxyl functionality in the range of 1.9 to 4. The part B hardener contains NCO functionality and comprises at least one of (i) a polyisocyanate-terminated polybutadiene resin having an average molecular weight in the range of 1000 to 5000 and an NCO content in the range of 8 to 15 percent by weight, and (ii) a multi-functional isocyanate having a molecular weight in the range of from about 200 to about 600. Part A and part B are combined in a near stoichiometric ratio between the polyhydroxy functionality and the NCO functionality.

In accordance with a still further embodiment of the invention, there is provided a cured elastomeric resin composition. The composition comprises polybutadiene blocks cross-linked via urethane linkages to other polybutadiene blocks with molecular bridges terminated by a pair of the urethane linkages. In preferred embodiments, the composition is highly adhesive and has excellent elongation and resilience over a wide temperature range. It is also very durable, tough and highly chemically resistant and maintains physical and chemical properties over time, not losing elongation or chemical resistance due to heat, UV light or weathering, unlike property loss demonstrated by other flexibilized thermosets over the years.

In accordance with yet another embodiment of the invention, there is provided an article of manufacture comprising a substrate and a cured elastomeric resin composition comprising polybutadiene blocks cross-linked via urethane linkages to other polybutadiene blocks with molecular bridges terminated by a pair of the urethane linkages deposited on the substrate. Examples of coated articles include concrete structures and metal chemical containment tanks as well as tanks and railcars.

Another embodiment of the invention provides a method for protecting a substrate from degradation. The method is carried out by applying a curable resin composition onto the substrate to a thickness in the range of from 5 to 500 mils. The curable resin composition comprises, in combination, a Part A and a Part B. Part A contains polyhydroxy functionality and comprises a polyhydroxy terminated polymer of butadiene having an average molecular weight in the range of 1,000 to 5,000 and an average hydroxyl functionality in the range of 1.9 to 4. Part B contains NCO functionality and comprises at least one of (i) a polyisocyanate-terminated polybutadiene resin having an average molecular weight in the range of 1000 to 5000 and an NCO content in the range of 8 to 15 percent by weight, and (ii) a multi-functional isocyanate having a molecular weight in the range of from about 200 to about 600. Part A and part B are combined in a near stoichiometric ratio between the polyhydroxy functionality and the NCO functionality and the composition is permitted to cure.

### BRIEF DESCRIPTION OF THE DRAWINGS

The drawing schematically illustrates in cross section a coated substrate in accordance with one embodiment of the invention.

### DETAILED DESCRIPTION OF THE INVENTION

The first part of the coating system (Part A) comprises a minimum of hydroxyl terminated butadienes. The material may be preferentially, optionally blended and specifically formulated for additional performance with incorporation of optional additives as described below, in section relating to “Part A: Polyol portion—optional additives.” The preferred optional additives are generally of lower molecular weight and are liquid resins selected from a second polyhydroxy-terminated polybutadiene, a polyhydroxy-terminated polyether, a polyhydroxy-terminated polyester, a polyhydroxy-terminated polyacrylate, a polyhydroxy-terminated propoxylated Bisphenol A, and a polyhydroxy-terminated polyester/polyether

When certain preferred optional additives are used, a novel resin composition is provided which comprises, in combination, a first polyhydroxy-containing component and a second polyhydroxy-containing component. The first polyhydroxy containing component comprises a polyhydroxy terminated polymer of butadiene having an average molecular weight in the range of 1,000 to 5,000, preferably in the range of 2,000 to 4,000, most preferably in the range of 2,500 to 3,500, and an average hydroxyl functionality in the range of 1.9 to 4, preferably in the range of 2 to 3. The second polyhydroxy-containing component comprises a compatible amount of at least one reactive polymer component of lower molecular weight selected from the group consisting of a second polyhydroxy-terminated polybutadiene, a polyhydroxy-terminated polyether, a polyhydroxy-terminated polyester, a polyhydroxy-terminated polyacrylate, a polyhydroxy-terminated propoxylated Bisphenol A, and a polyhydroxy-terminated polyester/polyether. The second polyhydroxy-containing component has an average molecular weight in the range of 500 to 2500 and an average hydroxyl functionality in the range of 1.5 to 3.

On a weight basis, the composition comprises from 0.01 to 100 parts by weight (pbw) of the first polyhydroxy-containing component for each part by weight of the second polyhydroxy-containing component, preferably in the range of 0.1-10 pbw of the first for each pbw of the second, and most preferably 0.3-3 pbw of the first for each pbw of the second.

Preferably, the second component comprises a second polyhydroxy-terminated polybutadiene or a polyhydroxy-terminated polyester/polyether as these materials have been employed with good results as shown by the examples herein.

When the second component comprises the second polyhydroxy-terminated polybutadiene, it is preferred that the first polyhydroxy-containing component has an average molecular weight in the range of 2,000 to 4,000 and the second polyhydroxy-containing component has an average molecular weight in the range 750 to 2,000. More preferably the first polyhydroxy-containing component has an average molecular weight in the range of 2,500 to 3,500 and the second polyhydroxy-containing component has an average molecular weight in the range 1,000 to 1,500. Both components preferably have an average hydroxyl functionality in the range of 1.5 to 3.

When the second component comprises a polyhydroxy-terminated polyester/polyether, the first polyhydroxy-containing component preferably has an average molecular weight in the range of 2,000 to 4,000

Examples of suitable hydroxy-terminated, 1,3-butadiene homopolymers are Sartomer Polybd R-45HTLO and Polybd R-20LM. These materials, with predominantly primary allylic hydroxyl groups, can be incorporated into the formulation to provide resilience and crosslinkability. These resins have hydrophobic, nonpolar hydrocarbon backbones. Both are linear polymers and exist as nonvolatile liquids at room temperature.

Poly bd® R-45HTLO is an example of a suitable hydroxyl terminated polymer of butadiene useful alone or as the first component in a two-component resin system. This resin has primary allylic alcohol groups that exhibit high reactivity. The viscosity of this resin is 8000 mPa·s @ 23° C. The hydroxyl number, mg KOH/g is 47.1 with an average hydroxyl functionality at 2.4-2.6. The molecular weight is 2800 Mₙ. The material is 99.9 wt. % non-volatile.

Poly bd® R-20LM is a hydroxyl terminated polymer of butadiene, and can be used as either the first component or the second component in the resin system. This resin has primary allylic alcohol groups that exhibit high reactivity. The viscosity of this resin is 2500 cps @ 30° C. The hydroxyl number, mg KOH/g is 420 with an average hydroxyl functionality at 1.8. The molecular weight is 1300 Mₙ. The material is 99.9 wt. % non-volatile. Using this lower molecular weight hydroxyl terminated resin yields a more highly cross-linked product which produces a film with increased hardness and chemical resistance. Increasing the loading of this ingredient (and the corresponding amount of hardener) will result in a harder material that has reduced elasticity. Decreasing the ingredient (and corresponding amount of hardener) will result in a softer coating with greater elongation properties. A range of 15-95%, final formulation is obtainable. In addition, other functionalized polymers, with either aromatic or aliphatic type backbones may substitute (also copolymers and modified homo/co polymers). The functional groups may include: alkyd, hydroxyl, carboxyl, amine, maleic anhydride, and virtually any other compound containing active hydrogen. Krasol LBH 2000 (Sartomer) is a linear polybutadiene polymer with hydroxyl end groups. Krasol LBH 2000 contains, based upon weight percent, a 65% 1,2-(vinyl), 12.5% 1,4-cis, and 22.5% 1,4-trans configurations for the unsaturation components. Due to the high concentration of olefinic double bonds, the material is particularly useful for use as a co-polymer for its excellent chemical resistance properties. Another example of a preferred second component is Sovermol 750. Sovermol 750 is a branched polyether/polyester with hydroxyl functionality. The viscosity of this resin is 800-1400 mPa·s (20° C. The hydroxyl number, mg KOH/g is 300-330. This resin imparts water repellency, which results in less sensitivity to moisture while curing. It also imparts UV resistance and stability and yields a more highly cross-linked product which produces a film with increased hardness and chemical resistance. The resin(s) are incorporated at 5 to 95% based on total weight of part A, preferably in the range of 30-80 wt. % and more preferably in the range of 40-70 wt. %.

Anti-oxidants can be used to protect the cured resin form thermal decomposition and improve long-term aging properties. They also protect the polymer from oxidative degradation, due to sheer heat generated, upon blending the polyol system. Because the polybutadienes contain a high concentration of unsaturated groups, these ingredients improve the thermal stability properties of the final product. Higher loading levels show improvement in thermal and long-term aging properties, where lower levels decrease the thermal stability and long-term aging properties of the coating. Phenol and non-phenol type anti-oxidants generally give the same results. Another example includes thioester antioxidants. Loadings range from 0.1 to 5% final formulation, part A. The class of hindered phenols show to be most effective. Irganox 2246 (2,2′-Methylene-bis-(4-methyl-6-tert.-butylphenol) (Ciba Specialty Chemicals), Irganox 1076 (Benzenepropanoic acid, 3,5-bis(1,1-dimethylethyl)-4-hydroxy-,octadecyl ester) (Ciba Specialty Chemicals), and Lowinox AH 25 (2,5-Bis(1,1-dimethylpropyl)-1,4-benzenediol (Great Lakes Chemical) are preferred materials.

The bubble breakers/anti-foam agents can be used to eliminate air entrapment, pinholes, and other surface imperfections. These ingredients improve the physical performance of the coating. A range of 0.01 to 5%, final formulation is obtainable. Foankill 8D (Crucible Chemical), AF 9000 (GE Silicones), BYK 054 (BYK Chemie), and BYK 500 (BYK Chemie) are preferred materials.

Alkali-metal alumino-silicate materials can be used as a molecular sieve adsorbent for static dehydration in the formulation, increasing shelf life of the product. This material is necessary for the removal of water from any components of the system. UOP L powder (A. B. Colby), a potassium calcium sodium aluminosilicate, and JACAAB P3, a molecular sieve supplied in castor oil (JACAAB, LLC.) are preferred materials. Usages are at 0.1 to 5%, final formulation.

Polyhydroxy-containing co-reactants can be incorporated into the polyol side of the coating system, such that they further polymerize the system at ambient, with heat, or compositions that form films that react with the isocyanate portion of the coating system. Co-reactants can also include materials that polymerize in the system independently of the isocyanate portion of the coating system. Physical properties of the system can be adjusted by the addition of auxiliary polyols to the formulation. A wide variety of hydroxyl functional polyol are contemplated herein including polyether (Bayer, PPG-1000), polyester (Bayer, Arcol LG-168), propoxylated bisphenol A (Milliken Chemical, Synfac 8027), hydroxyl-substituted acrylic resins (Bayer, Desmophen A), hydrocarbon oils (Polytung II, Degen Oil and Chemical), and hydroxyl functional reactive silicone oil Type B FM-44, Chisso America). The use of a short chain diol in conjunction with the required additional isocyanate increases the hard segment, urethane concentration, in the final polymer matrix. It is worth noting that 1-ethyl-1,3-hexanediol (Kyowa Hakko) is an effective polyol for this application and combination leads to increased hydrogen bonding between polymer chains and thus higher strength properties in the cured elastomer. Other co-polymer materials as recognized by those skilled in the art may be utilized. Ranges are from 5 to 80%, final weight. Sovermol 750 (Cognis), a branched polyether/polyester polyol, and Polybd R-20LM are preferred. Sovermol 750 is a fatty acid ester, approximately tri-hydroxy, average molecular weight approximately 561 g/mol.

Other polymerizable materials, such as short chain diamines or mixed alcohol diamines can be employed as auxiliary reactants with the system. With diamine extenders, further crosslinking is possible through urea and biuret formation, for example a melamine resin may be employed (Cymel 303 American Cyanamid), as others as recognized by those skilled in the art. Ranges are from 0.01 to 85%, final weight. Air Products offers aliphatic amines, aromatic amines, cycloaliphatic amines, dicyandiamides, imidazoles, all of which may be utilized.

Ethanolamines (Dow Specialty Alkanolamines) can be employed as auxiliary reactants with the system. With these alkanolamine materials, further crosslinking is possible and the time for cross-linking is reduced. Specific materials include monoethanolamine, diethanolamine, and triethanolamine, n,n-dimethylethanolamine, monoisopropanolamine, n,n-diethylethanolamine, n-methyldiethanolamine, and n-methylethanolamine. Loadings are typically 0.01 to 10%.

Oxazolidines hydrolyze with water to yield free amine and hydroxyl groups that react with isocyanate for form urea and urethane linkages. Difunctional oxazolidines yield higher functionality. Preferred materials are Zolidine RD-20 and Zoldine RD-4 (Angus Chemicals) at 0.1 to 5%.

Polyfunctional Aziridine (Bayer PFAZ 322 and PFAZ 321) can be utilized as a cross-linking agent and adhesion promoter and modifier. Added at 0.1% to 5% final formulation this material imparts higher solvent resistance, water resistance, and adhesion properties. This material is particularly useful for improving adhesion to substrates such as polyolefin, marble, stainless steel and glass. It is also beneficial as a catalyst, improving wear resistance of coating, and increasing antistatic properties.

Corcat P-12 (Bayer) is a highly branched cationic polymer (polyethylenimine) that, when incorporated at 0.1% to 20% final formulation has shown good stability to high salt concentrations as experienced in seawater conditions. Because of its cationic character, this material also serves as adhesion promoter to electronegative substances. The adhesive properties of the coating are overall improved by the ability of the primary and secondary amine groups to undergo hydrogen bonding in the coating-to-substrate adhesive mechanism.

Metal-organics (Gelest) based on silicone, germanium, tin, lead, titanium, zirconium and hafnium may be utilized for polymer grafting, followed by hydrolytic crosslinking. Usages are typically 0.001 to 5% by weight.

Amine functional silanes, such as 3-aminopropyl-triethoxysilane (Ameo (pure), Dynasylan) can be used as a coupling agent to facilitate greater resin to filler bonding. Usages are 0.001 to 5% by weight.

Z-6032 Silane (Dow Corning) contains a vinylbenzyl and amine organic and a trimethoxysilyl inorganic group. The product is supplied in methanol. Possessing both organic and inorganic reactivity, this product can react with organic polymers and inorganic mineral surfaces. As a coupling agent, it can be used as an additive to the polymer mixture. This material increases the flexural and tensile strengths of the system, and improves adhesion of the coating to substrate. The material can be utilized at 0.001 to 5% final formulation.

N-Dodecyl mercaptan (Sigma-Aldrich) it utilized for increased coating adhesion and to control cross-link density of the coating system. Usage is 0.001 to 2%.

Reactive diluents can be used to reduce the viscosity of the resin and to cross-link with the hardener. Increasing the loading of this ingredient (and the corresponding amount of hardener) will result in a harder material that has reduced elasticity. Decreasing the ingredient (and the corresponding amount of hardener) will result in a softer coating with greater elongation properties, while decreasing the viscosity of the uncross-linked resin. A range of 0.01 to 85%, final formulation is obtainable. In addition, other functionalized polymers, with either aromatic or aliphatic type backbones may be substituted. The functional groups may include: alkyd, hydroxyl, carboxyl, amine and virtually any other compound containing an active hydrogen. The polymers may have a range of functionalities/molecule. Harder, less flexible films are expected as functionality increases. Also, viscosities may range from around 1,000 cps upwards of 50,000 cps. Non-reactive diluents, such as plasticizers, oils, etc., may also be included. As another example, a mono-functional alcohol diluents results in a very soft “gel” coating, which enhances the system where foot traffic and ergodynamics are important. Materials include butyl glycidyl ether, C₈-C₁₀ aliphatic monoglycidal ether, cresyl glycidyl ether, and neopentyl glycol diglycidyl ether. The preferred material is 1,4 butanediol diglycidyl ether (Heloxy Modifier 67, Resolution Performance Polymers).

A monoalcohol may be used to limit the need for using a large excess of diisocyanate. 1-dodecanol (Sargent-Welch) is a preferred one. Loading is typically 0.01 to 5%.

Other specialized, optional co-resins can include (but not limited to) ethylene-vinyl acetate, polypropylene, ethylene-methyl acrylate EMA and ethylene-methyl methacrylate EMAA/polyethylene copolymers, polyethylene, polyethylene acid terpolymers, polyethylene ionomers, polyamide co- and ter-polymers, thermoplastic elastomers (TPE's), acrylonitrile-butadiene-styrene, acrylonitrile halogenated polyethylene, acrylonitrile halogenated styrene, acrylic-styrene-acrylonitrile, cellulose acetate, cellulose acetate-butyrate, cellulose acetate-propionate, halogenated polyethylene, halogenated polyvinyl chloride, polymonochlorotrifluoroethylene, diallyl phthalate, ethyl cellulose, ethylene-chlorotrifluoroethylene, ethylene-propylene, tetrafluoroethlyene-hexafluoropropylene-vinylidene fluoride ter-polymer, EVOH, PEBA, ethylene-tetrafluoroethylene, fluorinated ethylene-propylene, high-impact polystyrene, vinyl modified epoxy, liquid crystal polymer, methacrylate-butadiene-styrene, polyamide, polyamide-imide, polyacrylonitrile, polybutylene, polybutylene terephthalate, polycarbonate, polychlorotrifluoroethylene, polyphenylene ether copolymer, polyetherether ketone, polyphenylene ether homopolymer, polyetherimide, polyethylene oxide, polyethersulfone, phenyl-formaldehyde, perfluoroalkoxy, polyimide, polyisobutylene, polyisoethylene, paramethylstyrene, polymethylpentene, polyphenylene oxide, polyphenylene sulfide, polystyrene, polytetrafluoroethylene, polyurethane (polyester and polyether backbone), polyvinyl chloride, polyvinylidene fluoride, polyvinyl fluoride, styrene-acrylonitrile, styrene maleic anhydride, urea-formaldehyde, vinyl acetate-ethylene, polyacetal, polyacrylic, polyalkyd, polyallylic esters or allyis, cellulosic esters, halogenated polyalkylene ether, cyanate/cyanamide polymers, halogenated epoxies, cycloaliphatic epoxies, epoxyimide polymers, polyester polymers, polyether polymers, and polyphenylene.

Acrylic resin, A101 resin (Rohm & Hass), (a plasticizer) may be utilized as a film forming, non-reactive co-resin. The material improves weatherability of the coating. It is also possible to utilize low concentrations of non-functional butadiene. For example Ricon 130 (Sartomer) is a liquid polybutadiene with a viscosity of approximately 750 cps at ambient temperature. Loading range from 1.0 to 70%.

Lite mineral oil (Industrial Chemical and Supply, Houston, Tex.) (a non-reactive diluent) can be incorporated into the formulation to provide reduced viscosity and to extend the hydroxyl-terminated, 1,3-butadiene homopolymers (cost effective). Lower loadings of lite mineral oil will produce a harder, less elastic material—as well as reducing the viscosity of the blended resin system. Higher loadings of the lite mineral oil will produce a more viscous resin, which cures to yield a softer modulus material that has more elasticity. A broad range of 0.01 to 85%, final formulation is obtainable. Usually, in the range of 0.2 to 20%, and more preferably 0.5 to 10% is used. Oil materials that are longer in polymeric backbone chain length are noted to increase the physical properties of the coating. Petroleum hydrocarbon oils may also be used in conjunction with the lite mineral oil, as a diluent and resin extender. Other thermoplastic and non-thermoplastic resins with select fillers may be added at a range of 5-90% to modify end physicals of the coating. Toluenosulfonamide (Proflex 8, Deerland Chemical) can be utilized at 0.1 to 5%. This material reduces the viscosity and increases adhesion of the coating.

A list of generally compatible extenders (which may substituted in whole or in part for lite mineral oil) include: soybean oil, dioctyl phthalate, diundecyl phthalate, tricresyl phosphate, halogenated and non-halogenated paraffin, aromatic oils, naphthenic oils, alkyl naphthalenes, linseed oil, tung oil, detergent alkylate, fatty alcohols and their dicarboxylic acid esters, fatty acid esters of glycerol and other short chain alcohols, fatty acids, fatty acid amides, metallic soaps, oligomeric fatty acid esters (fatty acid complex esters), fatty acid esters of long-chain alcohols, montanic acid, esters and soaps, polar polyethylene waxes and their derivatives, nonpolar polyolefin waxes, natural and synthetic paraffin waxes, phthalates, monocarboxylic acid esters, acetates, propionates and butyrates, esters of ethylbutyric and ethylhexanoic acid, glycolic acid esters, benzoic acid esters, epoxidized fatty acid esters, plasticizers based on phthalic acids, aliphatic dicarboxylic acid esters, phosphates, polyester plasticizers, trimellitic acid esters, citric acid esters, sulfonic acid esters and sulfamides, alcohols, ethers and ketones, abietic acid esters, polymerizable plasticizers, hydrocarbons, halogenated hydrocarbons and other as recognized by those skilled in the art. Ranges are from 0.01 to 85%, final weight. The use of materials such as chlorinated waxes and oils also provides fire retardant properties to the finished coating. Santicizer 160 (Ferro Corp.) plasticizer provides improved stain resistance and fungal resistance versus DOP or other general purpose phthalates. Castor oil (Sea-Land Chemical Company) may also be utilized. Very high levels of oil or plasticizer (up to 85 parts per 15 parts by weight of butadiene polymer) will result in a jelly-like cured material with appeasing properties.

If the coating is to be exposed to UV radiation, light stabilizers may be incorporated into the formulation. UV stabilizers function to scavenge and neutralize free radicals in the coating that are produced upon exposure to ultraviolet radiation. These materials improve the stability of the unsaturated butadiene backbone. This mechanism maintains the integrity of the coating and improves long-term aging properties. Light stabilizers that may be incorporated include: benzophenone, benzotriazole, triazine, benzoxazinone, hindered amines, and hindered benzoate. For example, Tinuvin 292 (Ciba Specialty Chemicals) is a hindered amine that functions by absorbing incident U.V. radiation, and re-emitting the energy as heat. Other examples include Tinuvin 1130 (Ciba Specialty Chemicals), a benzotriazole, Sanduvor 3206 (Clariant), an oxalamide derivative. Preferred materials include Tinuvin P (Ciba Specialty Chemicals), Tinuvin 327 (Ciba Specialty Chemicals), and Tinuvin 765 (Ciba Specialty Chemicals). Loadings range from 0.001 to 30% final formulation, however 0.5% to 1% yields best results.

Surface Modifiers (surfactants) can be used to improve flow, eliminate air entrapment, orange peel, pinholes, craters, and other surface imperfections. This ingredient improves the flexibility of the coating. A range of 0.1 to 5%, final formulation is obtainable. Other acrylic (supplied as both liquid or on solid carrier particles) and non-acrylic modifiers yield virtually the same results (i.e., benzoin and acetylenic diols). Leveling agents include Fluorad FC-430 (3M Industrial Chemical Products Division) Dow 57 (Dow Corning Corporation).

Amorphous fumed silica can be used as a thickening agent/anti-settling agent/anti-sag agent. It prevents separation of incorporated ingredients when stored for long periods of time. Decreasing the loading of this material into the resin decreases the viscosity, anti-settling, and anti-sag properties. Increasing the loading of this material (loadings from 0.1 upwards of 25%) dramatically increases the viscosity, such that the resin is trowel-able, to apply to vertical surfaces and gaps in the substrate. The addition of the silica increases the physical properties of the coating, such as tensile strength Aerosil R202 (Degussa) is the preferred material.

BYK 410 and BYK 411 (BYK Chemie) can be utilized as a thickening agent/anti-settling agent/anti-sag agent. The produced thixotropic benefit versus applied sheer lends the products particularly useful for spray applied systems. Increasing the loading of this material (loadings from 0.1 upwards of 25%) dramatically increases the viscosity, such that the resin is trowel-able, to apply to vertical surfaces and gaps in the substrate. These solutions of modified liquid urea as sheer dependent thixotropes are typically used at loadings from 0.1 to upwards of 2.5%.

Carbon black will cause tensile, modulus, tear, and hardness to increase as the carbon loading is increased. In addition, carbon black gives the formulation the color of black. Typical loadings range from 0.1 to 40%, final formulation. (Cabot Corp.) Many other organic (Englehard) and inorganic pigments (Englehard) may be used. Titanium dioxide (TiPure 960, DuPont) can be used in combination with the carbon to provide a gray pigmented coating. Specialty pigments may include, for example, pearl and glow-in-dark effects. Loadings are 0.001 to 40%.

Texaphor 3241 (Cognus—Henkel Corporation) is a modified polyurethane polymeric wetting and dispersing agent which can be used for the deflocculation of organic and inorganic pigments. Loadings are between 0.001% to 5% for organic pigments, 0.01% to 5% for inorganic pigments.

U.V. active optical brighteners are materials such as 2,2′-(2,5-thiophenediyl) bis[5-tert-butylbenzoxazole] (Uvites OB, Ciba Geigy Corporation), can be used to provide brighter looking colors. This material may be incorporated into the elastomeric coating as a mechanism in which to detect pinholes and defects in the coating via UV light sources. Typical loadings are 0.01 to 50%, final formulation.

Fillers common the industry which can be used include, but are not limited to: aluminum oxide, calcium carbonates, dolomite, calcium sulfate, silicates, glass flake, surface modified glass flake, asbestos, kaolin, feldspar, and nepheline syenite, aollastonite, natural silicas, synthetic silicas, molybdenum disulfide, polytetrafluoroethylene, barium sulfate, metals and metal oxides, aluminum hydroxide, carbon, fibers (natural and synthetic—basalt, carbon polyamide, glass, boron, ceramic), electrically conducting fillers (stainless steel, carbon, carbon fibers, silver coated glass particles), radar absorbing materials, radiation shielding/EMI shielding (Tungsten powder), metal deactivators, magnetic additives (strontium ferrite and ceramics), and sound dampening materials such as dense fillers (e.g., Tungsten powder) combined with less dense fillers (e.g., hollow glass spheres). Some preferred materials include: ultra high molecular weight polyethylene (Inhance UH-1000 Series Particles), mica (Englehard), barytes (Cimbar Performance), attapulgite clay (Engelward), calcined kaolin (Engelhard) bentonite clays (Cimbar Performance), and talc (Luzenac America Inc.). Loadings for fillers may range from 0.0001 to 85%, final formulation. Typically increased loadings of fillers will cause the viscosity of the final formulation to increase.

Thermosetting powders, used for powder coating, may be incorporated for different chemical and physical properties. Alesta powder coatings (DuPont Performance Coatings) provide epoxy, epoxy-polyester hybrid, aromatic-urethane, polyester, aliphatic-urethane, siloxane, and silicone-polyester based resins. The incorporation of these materials is 0.1% to 85%, final formulation.

Ceramic microspheres (3M-W410 ceramic white, G400 ceramic gray) can be used for density control, reduced shrinkage, improved flow, low dielectric constant, and increased chemical/abrasion resistance. When incorporated into the polymer, scrubability, burnish and stain resistance are increased. The particle packing of the ceramic microspheres produces a coating with increased corrosion resistance via reduced film permeability. Usage may range from 0.01% to 85%, final formulation.

Floated glass bubbles (3M-Scotchlite H₂O/1000 epoxy silane surface treatment and S22 general purpose) are comprised of soda-lime-borosilicate glass. These materials provide excellent water resistance and are alternatives to control system density. Usage may range from 0.001% to 85%, final formulation.

Solid glass spheres (Potters Industries, Inc.—Spheriglass Solid Glass Spheres, Soda-Lime Glass) may also be utilized at 0.001 to 85%, final formulation.

Ryton PPS (Chevron Phillips Chemical Company LP—V-1, PR11, P-6) coating resins. This material, comprised of polyphenylene sulfide resins, are finely divided powders having a modest molecular weight and high melt flow. The powders may be useful to increase viscosity—for caulks, for example, and to provide non-stick, corrosion resistant benefits—it is especially useful for extreme aggressive chemical environments.

Zinc Oxide (Kadox-915, Zinc Corporation of America), and other metal oxides and certain ceramics, in addition to reinforcement, also provide resilience and thermal conductivity. This is an important filler, and can be used where enhanced thermal conductivity is of concern. Loadings are typically 0.001 to 85%, final formulation.

Non-thermal conductive materials (hollow glass spheres, air, gasses generated due to blowing agents and/or water, etc.) may be incorporated for the opposite effect. Loadings are at 0.001 to 85%, final formulation.

Flame-retardants include (but are not limited to): halogen liberating flame retardants, antimony oxide, phosphorous containing agents, modified silicones, alumina trihydrate, magnesium hydroxide, organically modified montmorillonite clay, expandable graphite, boric oxide, zinc borate, etc. Loadings, when used, are typically 0.01 to 70%, final weight.

Corrosion protection agents may include polyaniline, amino tri(methylene-phosphonic acid)—(ATMP), ammonium benzoate, sodium nitrite, 2-benzothiazolylthiosuccinic acid (MBTS), primary, secondary, and tertiary aliphatic amines, aliphatic diamines, cycloaliphatic and aromatic amines, polymethylimines, long-chain ethanolamines, imidazolines, amine salts of carbonic, carbamic, acetic, benzoic, oleic, nitrous, and chromic acids, acetylenic alcohols, lauric alcohol, alkyl chromates, organic esters of nitrous acid, organic esters of phthalic acid, organic esters of carbonic acid, nitronaphthalene, nitrobenzene, etc. The loadings, when used, may range from 0.01 to 40%, final formulation.

Antistatic agents (Ciba) prevent or at least reduce dust attraction, static discharge process that may damage the product (i.e., packaging and handling of electronic chips), and spark discharge that can produce serious accidents. Additives which can be used in loadings ranging between 0.01 to 40%, final formulation include:
Cationic compounds (best effect in polar substrates), generally consisting of a voluminous cation which often contains a long alkyl residue (i.e., quaternary ammonium, phosphonium or sulfonium salt, etc.). In most cases, the anion is the chloride, methosulfate or nitrate originating from the quaternization process.
Anionic compounds, mostly an alkyl sulfonate, sulfate or phosphate, a dithiocarbamate or carboxylate, alkali metals, etc.
Nonionic compounds, uncharged surface-active molecules including: polyethylene glycol esters or ethers, fatty acid esters or ethanolamides, mono- or diglycerides or ethoxylated fatty amines, etc.

Biostabilizers and antimicrobials can be used as a package preservative, can corrosion inhibitor, mold inhibitor (fungicide), and tannin stain blocking agent. Several commercially available agents are available, which typically base their chemistry on organic materials (i.e., Buckman Laboratories). Other materials may include zinc oxide, copper oxides, etc. The loadings range between about 0.01 to 15%, final formulation.

Dow Biocides offers a wide variety of ingredients for this application. Chemical blowing agents, when incorporated into the basecoat, release small amounts of gas—resulting in a foamed material. Examples include (but are not limited to) a mixture of sodium bicarbonate and acetic acid, chloro-fluorocarbons, etc. This material typically ranges between about 0.01 to 15%, final formulation, when present.

Scent additives (such as Stanley S. Schoenmann's products) provide an array of different fragrances that may be incorporated into the formulation. Loadings range between about 0.1 to 40%, final formulation, when used.

Bitter agents such as ground buffalo gourd may be incorporated into the coating to prevent damage by livestock (via oral degradation of the coating). Other ingredients include cayenne pepper powder, etc. Loadings are typically 0.001 to 85%, final formulation.

PTSI (para-toluenesulfonyl isocyanate) (ISOCHEM North America) reacts toward active hydrogen atoms, making it ideal for scavenging water and other isocyanate reactive groups (such as free acid in powdered aluminum alkanoates and active hydrogen present in carbon black pigments). This prevents the thickening of the formulation during storage. This material is especially useful for providing a contiguous coating film that is free of gaseous bubbles that may be generated when the coating is curing. These materials are particularly useful for one-step mechanisms. Loadings are typically 20-30 grams/gram of water, when used.

Anti-graffiti additives may be incorporated into the coating. These materials are modified silicones. Loadings are 0.1 to 10%, final weight, when used.

Preferred solvents include diisobutyl ketone, methyl isobutyl ketone and methyl ethyl ketone. The loadings are 0.1 to 15%, total weight, when used.

Catalysts, when used, are generally added to Part B of the system, or as a separate Part C. Catalysts which can be used to accelerate the cross-linking of the coating including: tertiary amines, alkoxides, carboxylates, metal salts and chelates (including tin, aluminum, potassium), organometallic compounds, acids, silanes (especially amine functional silanes). Loadings are typically 0.00001 to 5% final formulation. Specific products include DAMA 1010 (didecylmethylamine) (Albemarle), Polycat 41 (Air Products), 4-(Methylpiperidino) Pyridine (Reilly Industries), and Ancamine K54 (Air Products).

Metal-organics, Z6032 silane (currently in A side—presented formulas), non-reactive diluents, surface modifiers, fumed silica, BYK 410/411, carbon black, Texaphor 3241, optical brighteners, fillers, thermosetting powders, ceramic microspheres, solvents, floated glass bubbles, solid glass spheres, Ryton PPS, zinc Oxide, non-thermal conductive materials, flame-retardants, corrosion protection, antistatic agents, biostabilizers and antimicrobals, chemical blowing agents, scent additives, bitter agents, anti-graffiti additives, can be incorporated into the B side, if desired.

The second part of the coating system (Part B) comprises a polyfunctional harder reactable with the hydroxyls in the resin, and is preferably at least one polyisocyanate.

Preferably, the part B hardener contains NCO functionality and comprises at least one of (i) a polyisocyanate-terminated polybutadiene resin having an average molecular weight in the range of 1000 to 5000 and an NCO content in the range of 8 to 15 percent by weight, and (ii) a multi-functional isocyanate having a molecular weight in the range of from about 200 to about 600.

Krasol NN-25 (Sartomer) is an example of a suitable polyisocyanate-terminated polybutadiene resin having an average molecular weight in the range of 1000 to 5000 and an NCO content in the range of 8 to 15 percent by weight. It is an isocyanate-terminated prepolymer prepared from hydroxyl-terminated polybutadiene (Krasol LBH3000) resin and a modified diphenylmethane diisocyanate (MDI). The isocyanate groups of Krasol NN-25 undergo all of the reactions common to isocyanates, most notable the reactions used in polyurethane production. This resin has a viscosity of 1.2 Pas. at 25° C. The NCO group content, mol/Kg is 2.75. The material is cut with paraffin oil (20 wt %). The molecular weight, Mₙ=2500-3500. The microstructure consists of 18% 1,4-cis, approx. 17% 1,4-trans, and approx. 65% 1,2-vinyl. NN-25 can be used in either one-component or multiple-component hardener systems.

ISONATE 143L is an example of a suitable multi-functional isocyanate having a molecular weight in the range of from about 200 to about 600. This product has a low viscosity and good storage stability down to 75° F. (24° C.). The polycarbodiimide adduct offers extra flexibility because adduct formation is reversible (dissociation generates an additional isocyanate function). The carbodiimide linkage aids the stabilization of the polymer against hydrolytic degradation. Viscosity at 25° C.=33 cPs. This isocyanate equivalent is 144.5. The NCO content is 29.2 with a functionality of 2.1. 143L can be used in either one-component or multiple-component hardener systems.

A novel hardener composition in accordance with one embodiment of the invention comprises both an isocyanate-terminated polybutadiene resin having an average molecular weight in the range of 1000 to 5000, preferably in the range of 2,000 to 4,000, and most preferably in the range of 2,500 to 3,500, and an NCO content in the range of 8 to 15 percent by weight, such as the NN-25, together with a compatible amount of a multi-functional isocyanate having a molecular weight in the range of from about 200 to about 600, such as the 143L.

Thus, for the purposes one aspect of the invention, at least one diisocyanate functional polymer, or polyisocyanate functional polymer, and/or a multifunctional isocyanate, is used for the purpose of a hardener. It is added at a stoichiometric ratio corresponding to an OH/NCO ratio of approximately 0.80 to 2.0. Of course, other hardeners may be used as would be recognized by those skilled in the art. The diisocyanate is used to cross-link with the hydroxyl-terminated polybutadiene, the hydroxy functional diluent, if present, and active hydrogens contained in the coating mixture. Increasing the amount of hardener results in a harder film. Reducing the amount of hardener results in a softer film. By choosing the correct diisocyanate (and/or other polyfunctional isocyanate resins or materials) variables such as pot life and end physicals may be adjusted. Other multi-functional isocyanates may also be used including: aliphatic, aromatic, etc. Also, mono/polyfunctional amines and other hardeners recognized by those skilled in the art may substitute. Specific examples of materials that prove beneficial for the claimed invention include:

Isonate 143L (Dow Chemical Company), which is a polycarbodiimide-modified diphenylmethane diisocyanate, and Isonate 2143L (Dow Chemical Company) which is a modified MDI. Both materials are liquid at room temperature and found to be beneficial for the stabilization of the butadiene polymer against hydrolytic degradation—and increased hardness of the coating. Several other options, for example aliphatic isocyanates (Bayer Desmodur), aromatic isocyanates, and water-borne dispersions are supplied by Bayer Corp. Isonate 143L is preferred.

The material may be preferentially, optionally blended and specifically formulated for additional performance with incorporation of optional additives as described below, in section titled “Part B: Polyisocyanate portion—optional additives”

In the two component hardener system, the first component is preferably used in excess of the second. For example, in the range of 1 to 100 parts by weight of the first component for each part by weight of the second component, preferably in the range of 5 to 25 parts by weight.

Other additives can be included in Part B of the system. For example, co-reactants, U.V. stabilizers and absorbers, leveling agents, optical brighteners, mar and slip agents, catalyst, antioxidants, reactive diluents, and defoaming agents can be included. Examples include diamines, alkanolamines, amine functional silanes, typical catalysts, and PTSI (para-toluenesulfonyl isocyanate).

When the above materials (Krasol NN-25+Isonate 143L+Isonate 2143L) are blended together, under gaseous nitrogen, the addition of 0.001% to 0.01 benzolyl chloride has been found to enhance the shelf life stability of the isocyanate hardener blend. The items are blended together utilizing traditional blending equipment, then canned off in pails.

The curable material is a cost-effective plural component coating system comprising resin and hardener.

In accordance with another embodiment of the invention, there is provided a curable resin composition comprising a blend of polyhydroxyl terminated polybutadienes and polyisocyanates. Preferably, the curable resin composition comprises, in combination, a Part A and a Part B. Part A contains polyhydroxy functionality and comprises a polyhydroxy terminated polymer of butadiene having an average molecular weight in the range of 1,000 to 5,000 and an average hydroxyl functionality in the range of 1.9 to 4.

Part B contains NCO functionality and comprises at least one of (i) a polyisocyanate-terminated polybutadiene resin having an average molecular weight in the range of 1000 to 5000 and an NCO content in the range of 8 to 15 percent by weight, and (ii) a multi-functional isocyanate having a molecular weight in the range of from about 200 to about 600. Part A and part B are combined in a near stoichiometric ratio between the polyhydroxy functionality and the NCO functionality. Other components may be optionally present, but it is preferred that any such components be selected so that curable resin composition loses less than 20 percent of its weight in the form of VOCs as it cures, preferably less than 10%.

Preferably, the thermosetting elastomeric composition comprises at least hydroxyl terminated polybutadiene polymers and polyisocyanate functional butadiene polymers, at a stoichiometric OH to N═C═O index ratio preferably in the range of 0.80 to 2.0. More preferably the ratio of A:B is from 0.9 to 1.1 stoichiometrically.

The curable resin composition is high-solids content, meaning that it loses less than 20 percent of its weight in the form of VOCs as it cures, preferably less than 10%, more preferably less than 5%, and most preferably less than 1%. It is also preferred that the composition contain a small amount of part B in excess of an amount required to provide a stoichiometric amount, to bind up any excess water.

The curable resin composition will generally contain additional components, for example, in the range of 0.5 to 10 weight percent of a liquid extender oil, in the range of from about 0.1 to 5 percent by weight of a liquid surfactant surface modifier, in the range of from about 0.1 to 5 percent by weight of a liquid thixotropic agent, and in the range of from about 5 to 50 percent by weight of solid pigments, fillers and reinforcing agents.

Preferably, Part B comprises the polyisocyanate-terminated polybutadiene resin.

Part A preferably further comprises a second polyhydroxy terminated polymer of butadiene having an average molecular weight in the range of 1,000 to 5,000, or a polyhydroxy-terminated polyester/polyether.

In one preferred embodiment, part A comprises a polyhydroxy terminated polymer of butadiene having a molecular weight in the range of 2,000 to 4,000, preferably in the range of 2,500 to 3,500 and a second polyhydroxy terminated polymer of butadiene having a molecular weight in the range of 750 to 2,000, preferably in the range of 1,000 to 1,500. Part B comprises the polyisocyanate terminated polybutadiene resin having a molecular weight in the range of 2,000 to 4,000, preferably in the range of 2,500 to 3,500. Generally speaking, part A comprises in the range of 0.3-3 parts by weight of the polyhydroxy terminated polymer of butadiene for each part by weight of the second polyhydroxy terminated polymer of butadiene

In another preferred embodiment, part A comprises a polyhydroxy terminated polymer of butadiene having a molecular weight in the range of 2,000 to 4,000, preferably in the range of 2,500 to 3,500 and a polyhydroxy-terminated polyester/polyether having an average molecular weight in the range of 500 to 1500 and an average hydroxyl functionality in the range of 1.5 to 3. Part B comprises the polyisocyanate terminated polybutadiene resin having a molecular weight in the range of 2,000 to 4,000, preferably in the range of 2,500 to 3,500. Generally speaking, part A comprises in the range of 0.3-3 parts by weight of the polyhydroxy terminated polymer of butadiene for each part by weight of the polyhydroxy-terminated polyester/polyether.

By incorporation of appropriate catalysts and fillers, and/or adjusting the application temperature, pot-life and cure time of the coating may be adjusted from seconds to several days.

It is favorable to blend additional ingredients into the formulation. The elastomeric coating composition can optionally include one or more of a catalyst in a range between 0.00001 and 5%, preferably 0.00005 and 2.5%, and most preferably 0.01 to 2%, additional polyols for higher strength, specific performance, and viscosity control at 5 to 80%, other co-resins and diluents at 0.01 to 85%, fillers for corrosion resistant properties and other fillers recognized in the trade for cost benefits, sag control, and viscosity control between 0.0001 and 85%, functional silanes at 0.0001 to 5%, metal-organics at 0.001 to 5%, thermal conductivity agents between 0.01 and 85% of the formulation such as zinc oxide for resiliency and conductivity, and other fillers such as hollow and/or solid glass spheres (0.001 to 85%), drying agents such as para-toluenesulfonyl isocyanate, alkali-metal alumino silicates, oxazolidines, and aziridines ranging stoichiometrically up to 30 gram/gram of water present, flame retardants in amounts between 0.01 and 70%, wetting and dispersion agents at 0.001 to 5%, surfactants and defoamers at 0.1 to 5%, corrosion inhibitors ranging from 0.01 and 40%, antistatic agents ranging from 0.01 to 40%, biostabilizers and antimicrobals ranging from 0.01 to 15%, chemical blowing agents ranging from 0.01 to 15%, scent additives ranging from 0.1 to 40%, bittering agents ranging from 0.001 to 85%, pigments ranging from 0.00001 to 85%, UV optical brighteners/fluorescent whiting agents, ranging from 0.01 to 50%, anti oxidants at 0.1 to 5%, UV stabilizers ranging from 0.0001 to 30%, powdered (−10 to −1-250 mesh size) synthetic and natural polymers, 0.001 to 85%, anti-graffiti silicones at 0.1 to 10%, mar and slip agents at 0.1 to 10%, solvents such as diisobutyl ketone, methyl isobutyl ketone and methyl ethyl ketone at 0.1 to 15%.

The coating is prepared for application by mixing the first part (Part A) of the butadiene coating system containing the polyol and other additives, combined with the second part of the coating system (Part B) containing the isocyanates and other additives. This is typically accomplished in the field by pouring hardener (part B) into the part A container. The material is then mixed until homogeneous (typically 2 minutes with a jiffy type mixing blade). To the resin, a stoichiometric amount of hardener is added. An OH to N═C═O index ratio in the range of 0.80 to 2.0 is acceptable. Most preferred, an index of >1.05 is advantageous since it takes into account any water that may be present in the polyol resin, and water vapor present in the air. The excess isocyanate insures that all of the polyol resin will be chemically cross linked via its reaction with water to form polyurea. The scavenging of water is important to curb the unwanted reaction of the isocyanate with water. This reaction produces gaseous CO₂, and results in a film that is full of bubbles, pinholes and surface defects. Thus, it is important for film formation to incorporate this material into the formulation. The activated material is then ready to be applied to the desired substrate.

For coating purposes, the material can be applied by conventional application techniques including, but not limited to: brush applied, squeegee applied, roller applied, trowel applied, and spray applied (the material can be applied at ambient temperatures or warmed upwards of the flashpoint of the resin). The material provides excellent adhesion to a variety of materials including, but not limited to: concrete, aluminum, steel, glass, fiberglass, plastic, paper, wood, roofing shingles, rubber, ceramic, marble, leather, and synthetic foam, and a variety of low surface energy substrates.

The components of the elastomeric coating may also find industrial utility as a cast-able elastomer, sealant, caulk, grout, porous-membrane, sponge, foam, adhesive, potting and encapsulating compound, as well as other rubber-fabricated materials. All of these materials would prove useful to an applicator on the jobsite to use in conjunction with the presented coating. Typically, simply increasing the viscosity of the system via increased filler loads lends the material suitable for utility, specifically as a sealant, caulk, grout, porous-membrane, sponge, foam, and/or adhesive. The materials may then be specifically packaged for the end-user. An example would include a plural component caulking/sealing gun equipped with a static mixing element.

The cured elastomeric resin composition can be viewed as comprising polybutadiene blocks cross-linked via urethane linkages to other polybutadiene blocks with molecular bridges terminated by a pair of the urethane linkages. Where part B has polybutadiene blocks, the molecular bridges comprise polybutadiene blocks. Preferably the polybutadiene blocks have molecular weights in the 1,000 to 5,000 range. In preferred embodiments, the composition is highly adhesive and has excellent elongation and resilience over a wide temperature range. It is chemically resistant to attack by strong acids, strong alkalis, hydrocarbon fuels and oils, and alcohols. It is also very durable, tough and highly chemically resistant. For example, the cured resin composition can easily exhibit at least 40% elongation at break under ASTM D 412, it can have linear elongation over the range of −40 degrees F. to 200 degrees F. and memory from 25% elongation, it can have a tensile strength at break of at least 200 lb. force per square inch under ASTM D 412 and it can be resistant to decomposition from 100% adipic acid at 250 degrees F. for 72 hours.

In preferred embodiments, the cured resin composition has at least 100% elongation at break under ASTM D 412, a tensile strength at break of at least 500 lb. force per square inch under ASTM D 412, and a Shore A hardness of at least 60 under ASTM D-2240. For example, the cured resin composition can exhibit an elongation at break under ASTM D 412 in the range of 100-150%, a tensile strength at break under ASTM D 412 in the range of 500-1000 lb. force per square inch, and a Shore A hardness under ASTM D-2240 in the range of 60-90.

The cured resin composition will generally comprise in the range of 10 to 80 percent by weight of cured resin matrix, usually in the range of 20 to 60 percent by weight of cured resin matrix. Generally, the cured resin composition further comprises in the range of from 5 to 50 percent by weight of solid pigments, fillers and reinforcing agents embedded in the cured resin matrix.

In satisfaction of the foregoing objects and advantages, the present invention provides a coating system that comprises a chemically cross-linked elastomeric coating resting on a substrate, preferable a corrosion and erosion prone substrate such as metal or concrete.

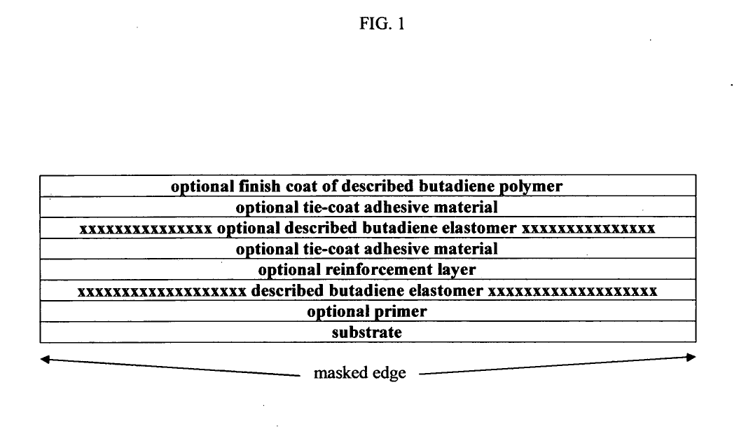

Referring to FIG. 1, an example of an inventive coating system is designated by the reference numeral 12. The elastomeric coating 4 is shown applied to the substrate 1. The substrate has an optional masked edge 2. Underlying the elastomeric coating basecoat is the optional primer 3. FIG. 1 also shows that an optional reinforcing layer 5 can be disposed in or on the elastomeric coating if desired. The optional tie-coat adhesive material 8 is applied to the reinforcing layer to achieve greater inter-coat adhesion to an additional layer 9 of butadiene coating. The optional additional butadiene coating layer 10 to build final film thickness is applied atop the optional materials. Preferably, any additional butadiene layers are placed over an adhesion promoter layer 11.

This aspect of the invention can be described as an article of manufacture comprising a substrate, and a cured elastomeric resin composition comprising polybutadiene blocks cross-linked via urethane linkages to other polybutadiene blocks with molecular bridges terminated by a pair of the urethane linkages deposited on the substrate. The substrate may be selected from the group consisting of aluminum, steel and concrete, and in such it preferably further comprises a primer deposited on the substrate. The primer is preferably selected from the group consisting of a silane primer and an epoxy primer. In another aspect, the substrate can be viewed as layer of fibrous reinforcement. In this event, the substrate preferably further comprises a tie-coat deposited on the layer of fibrous reinforcement. In another aspect, the substrate can be viewed as comprising a cured elastomeric resin composition. In this case, the substrate preferably further comprises an adhesion promoter deposited on the substrate. The article is preferably constructed before the underlying layer has reached final cure.

Examples of where this novel material finds utility in the market place include (but definitely are not limited to): coating of concrete (metal, ceramic, etc.), chemical containment vessels, drainage pipes and troughs, and pads, coating of secondary chemical containment areas, coating of sewage, water, and gas lines, coating of all construction components that encompass structural infrastructure and exostructure, applications that require a coating the cures under water (the described invention cures under water), coating of hard to adhere to materials, i.e. low surface energy substrates.

A correctly installed system adheres to virtually any substrate and is resistant to a wide range of chemicals (−100 to 260 deg F.). The material provides enhanced barrier properties to moisture and chemicals. Enhanced physical properties of the coating such as modulus and tensile and heat deflection temperatures, due to the reinforcing nature of the components, are realized. Enhanced dimensional stability and virtually no shrinkage are obtained with the coating. The material is able to bridge gaps and seams—surviving expansion and contraction of substrate (i.e. concrete expansion seams that thermally cycle through winter and summer). The resin provides exceptional adhesion, including when applied over a primer. Other attributes include the exceptional weatherability, flexibility, abrasion resistance, impact strength, and chip resistance. The film finish can be smooth or textured. The long-term aging properties of the material are exceptional.

The mixture may be applied by conventional application techniques including, but not limited to: brush applied, squeegee applied, roller applied, trowel applied, and both single and plural spray applied. For the single spray method, the Part A resin and Part B hardener, components are mixed and applied using commercial airless equipment. One method of dual spraying utilizes separate streams of the polyol and the isocyanate blend, which are mixed, via a static element mixing chamber, just prior to entering an air atomizing spray gun.

The invention further provides a method of coating at least a portion of a substrate by first mixing the hydroxyl terminated butadienes and isocyanates, preferably isocyanate terminated butadienes, to form a thermosetting mixture. The mixture is applied as a liquid to a substrate, preferably a substrate prone to erosion, corrosion, or chemical exposure, and the coating is allowed to form a chemically resistant elastomeric coating.

The invention additionally provides a method of coating at least a portion of a substrate by applying a silane primer or a silane modified thermoset (epoxy) primer composition for use with the elastomeric coating. The primer can be one of an ionic and an anionic silane; a methanol; organic phosphonium chloride salt and silane monomer, or any other silane having an active hydrogen. Several commercial silane materials are available.

This aspect of the invention can be viewed as a method for protecting a substrate from degradation due to chemical attack, abrasion, UV light and weathering as well as a method for bridging moving cracks in a substrate. The method is carried out by applying a curable resin composition onto the substrate to a thickness in the range of from 5 to 500 mils, preferably 10 to 100 mils, more preferably 20-70 mils. The curable resin composition comprises, in combination, a Part A and a Part B. Part A contains polyhydroxy functionality and comprises a polyhydroxy terminated polymer of butadiene having an average molecular weight in the range of 1,000 to 5,000 and an average hydroxyl functionality in the range of 1.9 to 4. Part B contains NCO functionality and comprises at least one of (i) a polyisocyanate-terminated polybutadiene resin, said polyisocyanate-terminated prepolymer having an average molecular weight in the range of 1000 to 5000 and an NCO content in the range of 8 to 15 percent by weight, and (ii) a multi-functional isocyanate having a molecular weight in the range of from about 200 to about 600. Part A and part B are combined in a near stoichiometric ratio between the polyhydroxy functionality and the NCO functionality, and the composition is permitted to cure.

In a preferred embodiment, the substrate further comprises a coating of a primer composition selected from the group consisting of a silane primer and an epoxy primer on the substrate, and the resin composition is applied onto the coated substrate. In such case, the method preferably further includes forming the coated substrate. More preferably, both the primer composition and the curable resin composition are applied to their respective substrates by spray technique.

The invention also provides a method of coating at least a portion of a substrate, by first an epoxy primer composition, for use with the elastomeric coating. The epoxy primer can be one of polyamine or polyamide cure. Several commercial products are available.

The invention also provides a method of incorporating a reinforcing material layer disposed between layers of the elastomeric coating.

Suitable reinforcing materials include glass, Kevlar, carbon, and the like. They can be fiber, roving, chopped strands, etc. Mostly hand lay-up with exception of chopped fibers, which may be applied via a chopping gun.

The system further comprises a method of utilizing a chemical resistant tie-coat adhesive material, applied to stated butadiene coating, to achieve greater inter-coat adhesion to additional layers of butadiene coating. Commercial products are available.

The tie-coat acts as an adhesion promoter for inter-coat adhesion. It is a water-like substance that is applied before applying described invention.

In a further aspect of the invention, the curable resin composition is applied in multiple coats to a final thickness in the range of 10 to 100 mils. A tie coat is preferably applied prior to the application of each coat of the curable resin composition.

This invention, when used as a field applied/shop applied coating allows the user to apply an elastomeric coating on a variety of substrates for the purpose of corrosion control.

This may be accomplished by application of the material onto typical substrates and primed substrates. Some of these primers may include, but are not limited to, functional silanes, epoxies, polyamines, polyamides, urethanes, acrylics, slurries, etc. As an example, an amino functional silane may be used to increase adhesion of this coating to glass. Another example would be the use of an epoxy primer, readily available via a variety of commercial suppliers, over concrete or steel, with the described invention applied on the primer. The system can further comprise a chemical resistant tie-coat adhesive material applied to stated butadiene coating, to achieve greater inter-coat adhesion to additional layers of butadiene coating.

One solution to erosion and corrosion control is according to the following technique:
1. The substrate is cleaned of contamination and debris. This is accomplished by mechanical (e.g. abrasive or hydro blasting, mechanical grinding, etc.), chemical means (acid etching, etc.), or any other known technique for cleaning concrete or steel.
2. The area to be coated can be masked, if desired or necessary, to appropriate dimensions with conventional masking products known in the art.
3. The optional primer can be applied to the substrate, at a typical thickness from 1 to 30 mils wet film thickness, used in the coatings industry.
4. The elastomeric coating is mixed (A-resin+B-hardener) and applied to the substrate (or optional primer). A thickness of 10-100 mils is preferred, but other thicknesses can be employed depending on the application.
5. Once the elastomeric coating is applied, and while still un-reacted (up to 2 hours), an optional reinforcing layer may be added to the system. One choice of material includes fiber (such as but not limited to: glass fibers, thermoplastic fibers, thermosetting plastic fibers, natural material such as cotton, carbon fibers, metal fibers, and ceramic fibers). The fiber may be applied by hand, spray, or other techniques recognized in the field. It is preferred (but not necessary) to mechanically roll the fiber into the basecoat with aid of hand held paint roller (or other applicable techniques).
6. Another option of reinforcement may include reinforcing fabrics (such as but not limited to: glass fibers, thermoplastic fibers, thermosetting plastic fibers, natural material such as cotton, carbon fibers, metal fibers, and ceramic fibers). It is preferred (but not necessary) to mechanically roll the fabric into the basecoat with aid of hand held paint roller (or other applicable techniques).
7. Once the elastomeric coating is ready, usually a minimum of 5 minutes to 2 hours after the application, the second layer may be applied as described in step 4.
8. The system can further comprise a chemical resistant tie-coat adhesive material, applied to stated butadiene coating, to achieve greater inter-coat adhesion to additional layers of butadiene coating (this is especially useful if the substrate layer of butadiene coating has cured past 72 hours).
9. Step 5 and 6 and optionally 8 may be repeated, as necessary, to provide the necessary engineered performance parameters. If optical brighteners are incorporated into the formulation, detection of pinholes and defects in the coating via UV light sources may be performed. The method of detecting pinholes and defects in the topcoat is as follows: 1) the system is correctly installed, and 2) a black light is scanned over the topcoat—pinholes and defects (thin spots) are illuminated (by the fluorescent whiting agent in the basecoat), thus detected. Once detected, additional elastomeric coating may be applied to seal the defect areas.
10. Two to 48 hours (70 deg F.) is typical to yield the final composite and/or elastomeric coating system. Excellent chemical resistance, physical properties, adhesion, serviceability, corrosion resistance, and erosion control are realized with this composite and/or elastomeric coating system.
11. Another option is to apply the coating/lining system to geo-textile fabric, applied directly over earthen berms or dikes or other substrates such as asphalt or other materials where the primer or coating system would not be compatible in achieving proper bond strengths. In this option, the coating/lining system employed is as described above herein, with the exception that it is applied to a fabric of geo textile or other fabric such as fiberglass reinforcement of random chopped strand mat or woven orientation. Other fabrics may also be used to achieve a surface above earth or non-compatible substrates and may include woven and non woven textiles of any fibrous make up compatible in bond to the coating/lining composition.
   Description of Preferred Materials and Composition Ranges for Elastomeric Coating

Examples of preferred elastomeric coating formulations (based on weight % of final formulation) are as follows:

### EXAMPLE #1

### Formula For Roll and Brush

Part A

| Ingredient | Percent wt/wt |
|---|---|
| R45HTLO | 31.62718 |
| Sovermol 750 | 32.48247 |
| black pigment dispersion | 9.699387 |
| UOP L powder | 1.942326 |
| Irganox 1076 | 0.484969 |
| Lowinox AH 25 | 0.484969 |
| Tinuvin 327 | 0.484969 |
| Tinuvin 765 | 0.484969 |
| mineral oil | 1.084795 |
| Proflex 8 | 0.775951 |
| Foamkill 8D | 1.748339 |
| BYK 054 | 0.193988 |
| BYK 500 | 0.145491 |
| Z6032 | 0.096994 |
| Chlorowax 50 | 0.193988 |
| 1/64″ glass flake | 0.170047 |
| 325 mica (wet ground) | 0.799404 |
| Wallsonite (325 mesh) | 7.994037 |
| glass sphere (3000) | 7.800149 |
| DIBK | 0.972388 |
| Ameo | 0.235954 |
| PTSI | 0.097239 |

Part B: Utilizing NN-25, mix ratios by volume (Part A resin to Part B polyisocyanate)=1:1.

### EXAMPLE #2

### General Formula For Spray Applied

Part A

| Ingredient | Percent wt/wt |
|---|---|
| R45HTLO | 31.1823147 |
| R-LM20 | 17.48376652 |
| TiO₂ | 2.773398072 |
| black pigment dispersion | 0.751128644 |
| Texaphor 3241 | 0.046223301 |
| UOP L Powder | 0.851967655 |
| Irganox 1076 | 0.451270458 |
| Lowinox AH 25 | 0.451270458 |
| mineral oil | 4.067258439 |
| Proflex 8 | 0.601693944 |
| Foamkill 8D | 0.84041528 |
| BYK 054 | 1.195125803 |
| BYK 500 | 0.153651985 |
| N-Dodecyl mercaptan | 0.300846972 |
| Z6032 | 0.090254092 |
| Chlorowax 50 | 6.609050538 |
| 1/64″ glass flake | 0.230259045 |
| 325 mica (wet ground) | 2.07882098 |
| Wallsonite (325 mesh) | 23.02590447 |
| MEK | 3.029679706 |
| DIBK | 1.977466778 |
| ameo | 1.657865122 |
| PTSI | 0.000001 |
| K-20 | 0.10044193 |
| BYK 410 | 0.049925112 |

Part B: Utilizing NN-25, mix ratios by volume (Part A resin to Part B polyisocyanate)=1:3.
Supplemental Description:
I. The composition of a two, or optionally three component, engineered, chemical resistant, elastomeric coating comprising essentially of, in weight percent based on final formulation—basic master match part A comprising a polyol blend:
   Part A
   a) between 10 and 90%, preferably 20 and 70, and most preferably 30 and 60% of hydroxy functional homopolymer;
   b) between 10 and 90%, preferably 20 and 70, and most preferably 30 and 60% of a mineral oil;
   c) between 0.1 and 30%, preferably 3 and 25, and most preferably 5 and 15% of a functional reactive diluent or co-polymer for reducing the viscosity of the composition;
   d) up to 5%, preferably 0.2 and 3%, and most preferably 0.3 and 1.0% of an degassing agent for improving surface imperfections, and aiding in air release;
   e) up to 5%, preferably 0.2 and 3%, and most preferably 0.3 and 1.0% of an anti-oxidant; and
   f) up to 25%, preferably 0.1 and 10%, and most preferably 0.5 and 2.0% of a thickening agent.
   Part B

The second component necessary for engineered, chemical resistant, elastomeric coating comprising essentially of, in weight percent based on final formulation—basic master match part B comprising a isocyanate+prepolymer blend:

between 10 and 90%, preferably 20 and 70, and most preferably 30 and 60% of hydroxy functional homopolymer;

a) Between 0 and 100% Krasol NN-25 (Sartomer).
b) Between 0 and 100% Isonate 143L (Dow Chemical Company).
II. The composition of I., optionally including one or more of a catalyst in a range between 0.00001 and 5%, preferably 0.00005 and 2.5%, and most preferably 0.01 to 2%, additional polyols for higher strength, specific performance, and viscosity control at 5 to 80%, other co-resins and diluents at 0.01 to 85%, fillers for corrosion resistant properties and other fillers recognized in the trade for cost benefits, sag control, and viscosity control between 0.0001 and 85%, functional silanes at 0.0001 to 5%, metal-organics at 0.001 to 5%, thermal conductivity agents between 0.01 and 85% of the formulation such as zinc oxide for resiliency and conductivity, and other fillers such as hollow and/or solid glass spheres (0.001 to 85%), drying agents such as para-toluenesulfonyl isocyanate, alkali-metal alumino silicates, oxazolidines, and aziridines ranging stoichiometrically up to 30 gram/gram of water present, flame retardants in amounts between 0.01 and 70%, wetting and dispersion agents at 0.001 to 5%, surfactants and defoamers at 0.1 to 5%, corrosion inhibitors ranging from 0.01 and 40%, antistatic agents ranging from 0.01 to 40%, biostabilizers and antimicrobals ranging from 0.01 to 15%, chemical blowing agents ranging from 0.01 to 15%, scent additives ranging from 0.1 to 40%, bittering agents ranging from 0.001 to 85%, pigments ranging from 0.00001 to 85%, UV optical brighteners/fluorescent whiting agents, ranging from 0.01 to 50%, anti oxidants at 0.1 to 5%, UV stabilizers ranging from 0.0001 to 30%, powdered (−10 to −1-250 mesh size) synthetic and natural polymers, 0.001 to 85%, anti-graffiti silicones at 0.1 to 10%, mar and slip agents at 0.1 to 10%, solvents such as diisobutyl ketone, methyl isobutyl ketone and methyl ethyl ketone at 0.1 to 15%, and polyisocyanate hardener at a stoichiometric OH to N═C═O index ratio, in the range of 0.80 to 2.0.
III. A method of forming a coating on at least a portion of a substrate by combining mixtures, as provided by I. and II.
IV. A method of forming a coating as described in I. and II., on at least a portion of a substrate combining with masking prior to application of coating.
V. The system of III. and IV., wherein an alcohol-silane primer is on the substrate and the coating of I. and II. applied to the primer.
VI. The system of III. and IV., wherein an epoxy primer is on the substrate and the coating of I. and II. is applied to the primer.
VII. The systems II. and IV., and optionally, V. and/or VI. wherein an optional reinforcement layer is utilized.
VIII. The system of II. and IV., and optionally V., VI., and VII., wherein an optional tie-coat adhesive material is applied to the stated butadiene coating, to achieve greater inter-coat adhesion to additional layers of butadiene coating. The optional butadiene coating applied atop the optional materials, but at minimum to preexisting butadiene substrate.
IX. All components and combinations thereof of II.-VIII., such that the last top coat layer is comprised of a coating, as provided in I. and II.

While certain preferred embodiments of the invention have been described herein, the invention is not to be construed as being so limited, except to the extent that such limitations are found in the claims.

1. A resin composition comprising
a first polyhydroxy-containing component comprising a polyhydroxy terminated polymer of butadiene having an average molecular weight in the range of 1,000 to 5,000 and an average hydroxyl functionality in the range of 1.9 to 4, and
in combination therewith, a compatible amount of a second polyhydroxy-containing component comprising at least one reactive polymer component of lower molecular weight selected from the group consisting of a second polyhydroxy-terminated polybutadiene, a polyhydroxy-terminated polyether, a polyhydroxy-terminated polyester, a polyhydroxy-terminated polyacrylate, a polyhydroxy-terminated propoxylated bisphenol A, and a polyhydroxy-terminated polyester/polyether, said reactive polymer component having an average molecular weight in the range of 500 to 2500 and an average hydroxyl functionality in the range of 1.5 to 3.

2-10. (canceled)

11. A hardener composition comprising
a first component comprising an isocyanate-terminated polybutadiene resin having an average molecular weight in the range of 1000 to 5000 and an NCO content in the range of 8 to 15 percent by weight, and,
in combination therewith, a compatible amount of second component comprising a multi-functional isocyanate having a molecular weight in the range of from about 200 to about 600.

12-15. (canceled)

16. A curable resin composition comprising, in combination, a Part A and a Part B, wherein
part A contains polyhydroxy functionality and comprises a polyhydroxy terminated polymer of butadiene having an average molecular weight in the range of 1,000 to 5,000 and an average hydroxyl functionality in the range of 1.9 to 4, and
part B contains NCO functionality and comprises at least one of (i) a polyisocyanate-terminated polybutadiene resin, said polyisocyanate-terminated resin having an average molecular weight in the range of 1000 to 5000 and an NCO content in the range of 8 to 15 percent by weight, and (ii) a multi-functional isocyanate having a molecular weight in the range of from about 200 to about 600,
wherein part A and part B are combined in a near stoichiometric ratio between the polyhydroxy functionality and the NCO functionality.

17. A curable resin composition as in claim 16 which loses less than 10 percent of its weight as it cures.

18. A curable resin composition as in claim 17 which contains a small amount of part B in excess of an amount required to provide a stoichiometric amount.

19. A curable resin composition as in claim 16 wherein part A further comprises in the range of 0.5 to 10 weight percent of a liquid extender oil, from 0.1 to 5 percent by weight of a liquid surfactant surface modifier, from 0.1 to 5 percent by weight of a liquid thixotropic agent, and from 5 to 50 percent by weight of solid pigments, fillers and reinforcing agents.

20. A curable resin composition as in claim 16 wherein part B comprises the poiyisocyanate-terminated polybutadiene resin.

21. A curable resin composition as in claim 10 wherein part A further comprises a second polyhydroxy terminated polymer of butadiene having an average molecular weight in the range of 1,000 to 5,000.

22. A curable resin composition as in claim 21 wherein part A comprises a polyhydroxy terminated polymer of butadiene having a molecular weight in the range of 2,000 to 4,000 and a second polyhydroxy terminated polymer of butadiene having a molecular weight in the range of 750 to 2,000 and part B comprising the polyisocyanate terminated polybutadiene resin has a molecular weight in the range of 2,000 to 4,000.

23. A curable resin composition as in claim 22 wherein part A comprises a polyhydroxy terminated polymer of butadiene having a molecular weight in the range of 2,500 to 3,500 and a second polyhydroxy terminated polymer of butadiene having a molecular weight in the range of 1,000 to 1,500 and part B comprising the polyisocyanate terminated polybutadiene resin has a molecular weight in the range of 2,500 to 3,500.

24. A curable resin composition as in claim 20 wherein part A further comprises a polyhydroxy-terminated polyester/polyether.

25. A curable resin composition as in claim 24 wherein the polyhydroxy terminated polymer of butadiene has a molecular weight in the range of 2,000 to 4,000 and the polyhydroxy-terminated polyester/polyether has an average molecular weight in the range of 500 to 1500 and an average hydroxyl functionality in the range of 1.5 to 3.

26. A curable resin composition as in claim 25 wherein the polyhydroxy terminated polymer of butadiene has a molecular weight in the range of 2,500 to 3,500 and the polyisocyanate terminated polybutadiene resin has a molecular weight in the range of 2,500 to 3,500.

27. A curable resin composition as in claim 26 comprising in the range of 0.3-3 parts by weight of the polyhydroxy terminated polymer of butadiene for each part by weight of the polyhydroxy-terminated polyester/polyether.

28. A method for making a curable resin composition, said curable resin composition comprising a blend of a part A resin and a part B hardener, said method comprising
providing an amount by volume of a liquid part A resin which contains polyhydroxy functionality and comprises a polyhydroxy terminated polymer of butadiene having an average molecular weight in the range of 1,000 to 5,000 and an average hydroxyl functionality in the range of 1.9 to 4, and
combining into said part A resin with stirring an amount of a liquid part B hardener which contains NCO functionality and comprises at least one of (i) a polyisocyanate-terminated polybutadiene resin, said polyisocyanate-terminated polybutadiene resin having an average molecular weight in the range of 1000 to 5000 and an NCO content in the range of 8 to 15 percent by weight, and (ii) a multi-functional isocyanate having a molecular weight in the range of from about 200 to about 600,
wherein part A and part B are combined in a near stoichiometric ratio between the polyhydroxy functionality and the NCO functionality.

29. A cured elastomeric resin composition comprising polybutadiene blocks cross-linked via urethane linkages to other polybutadiene blocks with molecular bridges terminated by a pair of the urethane linkages.

30. A cured resin composition as in claim 29 wherein a major portion, based on weight, of the polybutadiene blocks have a molecular weight in the range of 1,000 to 5,000.

31. A cured resin composition as in claim 30 wherein the molecular bridges comprise polybutadiene blocks.

32. A cured resin composition as in claim 31 wherein a major portion, based on weight, of the polybutadiene blocks in the molecular bridges have a molecular weight in the range of 1,000 to 5,000.

33. A cured resin composition as in claim 29 which has at least 40% elongation at break under ASTM D 412.

34. A cured resin composition as in claim 33 which has linear elongation over the range of −40 degrees F. to 200 degrees F. and memory from 25% elongation.

35. A cured resin composition as in claim 34 which has a tensile strength at break of at least 200 lb. force per square inch under ASTM D 412.

36. A cured resin composition as in claim 35 which is resistant to decomposition from 100% adipic acid at 250 degrees F. for 72 hours.

37. A cured resin composition as in claim 32 comprising in the range of 10 to 80 percent by weight of cured resin matrix.

38. A cured resin composition as in claim 37 comprising in the range of 20 to 60 percent by weight of cured resin matrix.

39. A cured resin composition as in claim 38 further comprising in the range of from 5 to 50 percent by weight of solid pigments, fillers and reinforcing agents embedded in the cured resin matrix.

40. A cured resin composition as in claim 39 which has at least 100% elongation at break under ASTM D 412, a tensile strength at break of at least 500 lb. force per square inch under ASTM D 412, and a Shore A hardness of at least 60 under ASTM D-2240.

41. A cured resin composition as in claim 40 which has an elongation at break under ASTM D 412 in the range of 100-150%, a tensile strength at break under ASTM D 412 in the range of 500-1000 lb. force per square inch, and a Shore A hardness under ASTM D-2240 in the range of 60-90.

42. A cured resin composition as in claim 41 which is chemically resistant to attack by strong acids, strong alkalis, hydrocarbon fuels and oils, and alcohols.

43. An article of manufacture comprising
a substrate,
a cured elastomeric resin composition comprising polybutadiene blocks cross-linked via urethane linkages to other polybutadiene blocks with molecular bridges terminated by a pair of the urethane linkages deposited on the substrate.

44. An article of manufacture as in claim 43 wherein
the substrate is selected from the group consisting of aluminum, steel and concrete.

45. An article of manufacture as in claim 44 wherein the substrate further comprises a primer deposited on the substrate, the cured elastomeric resin composition being deposited on the primer, wherein the primer is selected from the group consisting of a silane primer and an epoxy primer.

46. An article of manufacture as in claim 43 wherein
the substrate further comprises a layer of fibrous reinforcement.

47. An article of manufacture as in claim 46 wherein the substrate further comprises a tie-coat deposited on the layer of fibrous reinforcement.

48. An article of manufacture as in claim 43 wherein the substrate comprises a layer of a cured elastomeric resin composition comprising polybutadiene blocks cross-linked via urethane linkages to other polybutadiene blocks with molecular bridges terminated by a pair of the urethane linkages.

49. An article of manufacture as in claim 48 wherein the substrate further comprises an adhesion promoter deposited on the cured elastomeric resin composition forming the substrate.

50. A method for protecting a substrate from degradation, said method comprising
applying a curable resin composition onto a substrate to a thickness in the range of from 5 to 500 mils, said curable resin composition comprising, in combination, a Part A and a Part B, wherein
part A contains polyhydroxy functionality and comprises a polyhydroxy terminated polymer of butadiene having an average molecular weight in the range of 1,000 to 5,000 and an average hydroxyl functionality in the range of 1.9 to 4, and part B contains NCO functionality and comprises at least one of (i) a polyisocyanate-terminated prepolymer prepared from a polyhydroxyl-terminated polybutadiene resin, said polyisocyanate-terminated prepolymer having an average molecular weight in the range of 1000 to 5000 and an NCO content in the range of 8 to 15 percent by weight, and (ii) a multi-functional isocyanate having a molecular weight in the range of from about 200 to about 600,
wherein part A and part B are combined in a near stoichiometric ratio between the polyhydroxy functionality and the NCO functionality,
and permitting the composition to cure.

51-55. (canceled)
